(19) United States
(12) Patent Application Publication
(10) Pub. No.: US 2015/0355637 A1
(43) Pub. Date: Dec. 10, 2015

(54) REMOTE SPEED MANAGEMENT SYSTEM FOR VEHICLES

(71) Applicant: MAGTEC PRODUCTS, INC., Calgary (CA)

(72) Inventor: MICHEL R. MORISSET, Calgary (CA)

(21) Appl. No.: 14/735,993

(22) Filed: Jun. 10, 2015

Related U.S. Application Data
(60) Provisional application No. 62/010,443, filed on Jun. 10, 2014.

(51) Int. Cl. G05D 1/00; G05D 13/02

(52) U.S. Cl. CPC G05D 1/0027; G05D 1/0022; G05D 13/02

(57) ABSTRACT

The present invention relates generally to an onboard controller system. More particularly, the present invention relates to a vehicle control unit for remotely managing the top speed of a vehicle. In accordance with one embodiment, the present invention further comprises auditing means that can function to monitor, log and report on vehicle information or events, which may be real-time. Vehicle information or events may include, for example, vehicle speed, governor settings, vehicle location and time, changes in equipment settings, as well breaches by a vehicle operator, including speeding or tampering by a vehicle operator.

### FIELD OF THE INVENTION

The present invention relates generally to an onboard controller system. More particularly, the present invention relates to a vehicle control unit for remotely managing the top speed of a vehicle with the ability to monitor, log and report vehicle speed, governor settings and transactions (commands, violations, tampering, etc) on a secure and auditable basis, and which may be responsive or adaptive based on vehicle location.

### BACKGROUND OF THE INVENTION

One known method for managing the top speed of a vehicle involves the manual adjustment of the top speed value in the engine control module (ECM). If the vehicle is a heavy vehicle and uses J1939 or equivalent data provided and managed through the engine control module (ECM), then vehicle dealers or maintenance shops may manually adjust the top speed value in the ECM. However, the value in the ECM cannot thereby be remotely managed. A vehicle operator would be required to stop in order to have this value modified by a qualified shop. Further, if the vehicle is a light vehicle, the top speed in the ECM cannot be managed, because the interface to the control systems of the vehicle is not as accessible.

Another method of auditing the control of vehicle speeds, thus managing speeds by managing the operator's behavior, involves the use of speed data which must be logged and reviewed afterwards in order to identify whether a vehicle was speeding. However, such method is not conducted in real-time and safely and adherence to policy or law must be enforced after the fact.

It is therefore desirable to allow for remote configuration of the top speed of a vehicle in real time regardless of vehicle type. It is also desirable to have the ability to monitor, log and report on a secure and auditable basis information such as that related to vehicle top speed (governor) settings and breaches including tampering or speeding.

### SUMMARY OF THE INVENTION

It is an object of the present invention to obviate or mitigate at least one disadvantage of previous methods and systems for managing the speed of a vehicle.

It is a further object of the present invention to enable a user to remotely set, control and geo-fence maximum speeds of a vehicle in real-time. Once the vehicle reaches the set speed limit, the system of the present invention may also act to prevent the vehicle from exceeding it.

The present invention may implement particular software, such as for example, MCC Software (Mobile Command and Control), to remotely adjust the speed limit setting on a vehicle (or fleet wide) within minutes.

It is a further object of the present invention to allow for speed violations to be logged in and viewed on, for example, a number of fleet reports, to identify tampering or downhill speeding. Real-time event notifications may also be set, for example, to alert authorized personnel of any tampering or limit violations.

Some jurisdictions regulate top speed governor requirements for their highways, requiring “installations” of governors set to their local rules on commercial vehicles (of some classes) as part of licensing requirements to operate those vehicles on their roadways. This invention allows for compliance and audit to replace physical and tamper-evident governor resets at jurisdictional borders, or setting of top speeds at the slowest jurisdictional rule rates for the vehicle's planned or authorized travel.

The present invention may also maximize fuel efficiencies resulting in savings in fuel and operational costs along with improving environmental performance and safety.

### BRIEF DESCRIPTION OF THE DRAWINGS

FIG. 1 is an OCS of the present invention.

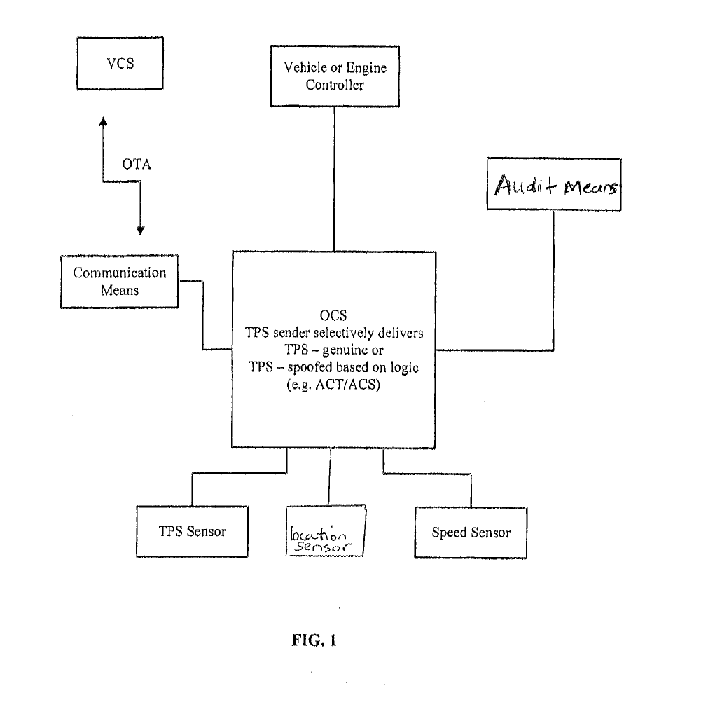

### DETAILED DESCRIPTION

Generally the present invention provides a method and system for remotely controlling the speed limit of the vehicle in real-time. The present invention also provides an auditing function for monitoring, logging and reporting vehicle speed, governor settings and transactions (i.e. speed violations, tampering, etc.). The following describes one embodiment:

### Throttle Position Sensor (Genuine Signal):

A throttle position sensor of a vehicle generates a signal based on the throttle position and that signal is delivered to the vehicle electronic control module (ECM), data bus, engine management system or other system used by the vehicle to control operations. The signal may be analog, digital (e.g. pulse width modulation (PWM)), fibre optic, electromagnetic or other signals known in the art.

### Throttle Position Generator (Spoofed Signal)

A throttle position generator generates a signal based on the output of a controller for the Acceleration Control System (ACS)/Acceleration Control Technology (ACT). The throttle position generator is configured with the vehicle at idle state and the signal from the throttle position sensor measured to provide a baseline TP and an internal gain G set to calibrate the throttle position generator to match throttle position sensor signals on the particular vehicle. The Throttle Position Generator is then capable of generating a signal which the vehicle can interpret as if it were a genuine throttle position signal (spoofed signal).

### Acceleration Control Technology (ACT)

ACT provides for selectively intervening to deny the ability of the operator of the vehicle to generate instructions to the vehicle's engine to increase or maintain the vehicle's speed. In a preferred embodiment, the controller is programmed for setting, receives an Acceleration Control System (ACS) signal for setting, or generates a number of steps (ACS_Steps) and time (ACS_time). Using the vehicle speed, for example from GPS or speed sensor (for example from the speed sensor voltage (SSV)), ACS_Steps number of threshold points (ACS_threshold) are generated. The controller applies the logic: if SSV less than or equal to ACS_threshold, then deliver TPS_genuine to vehicle, and if SSV greater than ACS_threshold, then deliver TPS_spoofed to vehicle (e.g. to engine control module). This is held for ACS_time, at which point ACS_threshold is dropped to the next value.

As an example: If ACS_steps=7, ACS_time=45 seconds, and the SSV corresponds to 100 km/hour, ACS_threshold points would be (approximately): 100, 86, 72, 58, 44, 30, and 16. Upon triggering the ACS, the operator of the vehicle would be allowed control the speed of the vehicle at speeds of 0-100 km/hour, but if the operator tried to increase speed above 100 km/hour, the controller would deliver the TPS_spoofed signal corresponding up to 100 km/hour rather than the TPS_genuine signal corresponding to the TPS. After 45 seconds, the controller would make the TPS_genuine/TPS_spoofed selection at 86 km/hour, then after another 45 seconds at 72 km/hour and so on until the vehicle is controlled at 16 km/hour (i.e. 270 seconds into it).

In another embodiment, for example, ACT may reduce the vehicle's speed in preset increments, for example 10 km/hour every 30 seconds, which allows the vehicle to be slowly and safely brought to a controlled stop.

The ACS trigger, or, initiation system signal can be generated onboard, for example, by triggering a hidden switch, or receiving a hijack or duress code from a driver authentication system, or the ACS could be triggered by an over the air (OTA) signal via satellite, cellular, electromagnetic, radio frequency or other system.

### Safety Control Override

Depending on the vehicle and terrain, there are situations where it may be less safe to interfere with the TPS_genuine signal and replace it with the TPS_spoofed signal. One example is where the vehicle is a loaded semi-trailer truck/tractor trailer traveling downhill. In such a situation, safety and vehicle control are maintained or increased by providing the TPS_genuine signal rather than the TPS_spoofed signal, thus allowing the operator of the vehicle, for example, to increase engine speed in order to change into a lower gear in the case of a manual transmission or otherwise gives the operator a chance to manipulate the engine or transmission to deal with the environment. In the preferred embodiment, the controller may poll or detect the vehicle speed, for example from the SSV, and if the vehicle accelerates despite the controller providing the TPS_spoofed signal instead of the TPS_genuine signal, then the controller can override and provide the TPS_genuine. The vehicle control unit may include a device or means for determining declination or angle of travel for the vehicle, to determine if, in fact, the vehicle is traveling downhill.

### Auditing Means

In accordance with one embodiment, the present invention further comprises auditing means that can function to monitor, log and report on vehicle information or events in real-time. As such, creating an “audit trail” for particular vehicle information or events. In a preferred embodiment, communications such as OTA are provided at least periodically on a secure and/or encrypted auditable basis, and may be done in real time.

Vehicle information or events can comprise, for example, vehicle speed, governor settings, vehicle location and time. Event notifications can also include particular transactions, such as commands, breaches, changes to vehicle ACS_Threshold or similar governor-like speed settings, etc. Breaches by a vehicle and/or operator, can for example, include operator speeding including downhill speeding, and tampering or interference by a vehicle operator, such as, for example, interference with the ACT.

The audit function, which preferably is performed by secure and/or encrypted communications means, should be accepted by most regulatory bodies as evidence that in fact, physical governor functions have been provided while the vehicle was in their jurisdiction. This may permit ease of compliance with vehicles licensing regulatory regimes absent physical, mechanical or electronic governor resets.

The present invention may consequently allow for speed violations to be logged in and viewed on, for example, a number of fleet reports, to identify tampering or downhill speeding or allowing real-time event notifications to be set, for example, to alert authorized personnel of any tampering.

In accordance with embodiments of the present invention, the audit means can include a “safe data store” which can be located onboard the vehicle, for example, in the MCC or ACT or in a “black box recorder” remote from the MCC or ACT. Alternatively, the audit means safe data store can be located at a remote storage facility accessible OTA, which may be considered as a standalone, archival, backup, original or duplicate record.

In one embodiment, the audit means safe data store could record, in a tamperproof or tamper evident and secure way, transactions with the MCC or ACT which in any way affected the rules used in the MCC or ACT to set the upper speed of the governor function. Fault and tampering events could also be recorded.

Consequently, by way of example, the audit means may gather evidence of the state of the upper speed limit rules for the physical governor at a time during which the vehicle was at a given location. The location of the vehicle may be measurable or determinable from location information gathered about the vehicle and which may be time-stamped. The information may be stored in the “safe data store”, but may also be gathered and stored separately. The minimum information in the “safe data store” may provide evidence of the speed settings of the governor at relevant times and thus locations of interest to the operator or regulators, interested in the operation of the vehicle.

### Other Systems

While described as controlling the TPS by selectively sending the genuine or spoofed throttle control position signal, the method and system of the present invention is also enabled by use of other common vehicle systems, which may or may not apply depending on a particular vehicle or type of vehicle. These other vehicle systems include, but are not limited to: transmission operation or gear (e.g. automatic transmission, or electronically controlled transmission), vehicle data bus (e.g. CANbus/CANcontroller, J1850, OBD etc.), engine control module (ECM), powertrain control module (PCM), fuel system, air system, spark system, diesel injector system, engine detune, engine valve bleedoff (e.g. Jake BrakeTm), clutch, torque converter, automatic speed control system (cruise control), traction control system, braking system, propeller pitch, rudder control, flaps, thrust reversers, trim, differential slip, steering, etc.

Features of the present invention may be incorporated into a stand-alone system which is designed to add on to the vehicle, or may be incorporated into the vehicle's existing systems by the original equipment manufacturer (OEM).

### Other Vehicles

While described as preferably applicable to tractor-trailer trucks, the system and methods of the present invention may be applicable to a wide variety of vehicles, including, (but not limited to) cars, trucks, buses, boats, planes, ships, construction vehicles, industrial vehicles, off-road vehicles, military vehicles, commercial vehicles, heavy machines, trains, people movers, etc. and are applicable to generally any form of motive force such as gas, electric, diesel, fuel cell etc.

The OCS and a vehicle control system (VCS) may communicate, for example by over the air systems previously mentioned. Among other things, the VCS may communicate an ACS signal to the OCS or send or receive commands to/from the OCS or send or receive driver code additions/deletions etc.

### EXAMPLES

In a preferred embodiment of the present invention, a user may be enabled to remotely set, control and geo-fence maximum speeds of a vehicle, perhaps even in real-time. Once the vehicle reaches the set speed limit, the system of the present invention may also act to prevent the vehicle from exceeding it.

The present invention may implement particular software, such as for example, MCC Software (Mobile Command and Control), which may be used to remotely adjust the speed limit setting on a vehicle (or fleet wide) potentially within minutes.

A communication system may facilitate the movement of data from hosted software to the vehicle on-board device. As such, the speed may be set at the software and the top-speed setting may be moved to the on-board device. The on-board device may then watch the vehicle speed and restrict the speed at the set point. Changes to the set point may be logged, and the logs may be auditable.

The present invention may encompass a method facilitated by a system that adds, changes and deletes the speed settings at the vehicle device, which may be logged in an auditable way.

In a preferred embodiment, the system of the present invention can include a method of self-correction and self-calibration in order to ensure idle voltages are always known and set accordingly when speed restriction is necessary.

Further, in a preferred embodiment, the present invention can allow for speed or other violations to be logged in and viewed, for example, on a number of fleet reports to identify; violations may include, for example: vehicle operator tampering or downhill speeding. Real-time event notifications may also be set, for example, to alert authorized personnel, regulators, or others of any tampering or other violation.

Standalone daughter board or Enhanced (Smart) TPS Expander

The concept of the present invention may utilize LMU to determine vehicle speed through either OBD2 or GPS, the set point may be configurable through software, such as MCC software. When the vehicle speed exceeds the set point the LMU switches a LiNK (TM etc.) output to activate the TPS expander.

A smart TPS module similar to existing TPS expander boards is designed for control 3 circuits TPS's. When activated it will spoof an idle voltage to the ECM and will automatically and continuously calibrate, and monitor input and output voltage to match idle voltage.

Monitoring for tampering may be needed, for example signaling the LMU if it has been disconnected from the TPS. Ideally, powered from the +5 v wires from the TPS and/or powered from the LMU, to minimize vehicle connection points and simplify installation.

In accordance with one embodiment, a vehicle-specific harnesses may be prebuilt in order to simplify the installation process.

In accordance with an embodiment, MCC enhancements may be implemented to provide UI for easy adjustments, geofence rules (device & app), geocode rules, speed gauge integration, etc.

In accordance with an embodiment, the present invention may utilize LMU for speed with OBD2, J1939, J1708, GPS.

In accordance with a further embodiments, the system of the present invention may utilize GPS as a back-up for vehicle speed. For example, if CAN is unplugged, the system may limit vehicle speed to 80% of the set point (as an option).

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method for the real-time management of the speed of a vehicle or fleet of vehicles comprising the steps of:
a. selecting a variable maximum vehicle speed remotely;
b. controlling the vehicle or the fleet of vehicles from exceeding the selected maximum vehicle speed by allowing operator control if the engine speed is less than the maximum speed and interfering with operator control if the engine speed is greater than the selected maximum vehicle speed; and
c. auditing vehicle information or events in real-time.

2. The method of claim 1, further comprising the step of programming or setting a maximum speed.

3. The method of claim 2, wherein the step of programming or setting a maximum speed is implemented through software.

4. The method of claim 3, wherein the software comprises Mobile Command and Control software.

5. The method of claim 3, wherein the maximum speed is set responsive to over the air signals.

6. The method of claim 3, wherein a device on board the vehicle receives the over the air signals and restricts the vehicle speed at the selected maximum speed.

7. The method of claim 1, further comprising the step of adjusting the selected maximum vehicle speed on the basis of vehicle information or external factors.

8. The method of claim 7, wherein the step of adjusting the selected maximum vehicle speed is automatic.

9. The method of claim 7, wherein the vehicle information or external factors include at least one location-based factor, comprising one or more of: variable road situations, variable zone situations, posted speed limits, site speed limits, oversize load speed limits, vehicle type speed limits or driver behavior speed limits, and vehicle's actual location.

10. The method of claim 1, wherein the step of auditing vehicle information or events in real-time comprises providing real-time event notifications by secure communication means.

11. The method of claim 10, wherein the real-time event notifications comprise at least one of vehicle speed, governor settings, interfering with Acceleration Control Technology, the vehicle location information and time.

12. The method of claim 10, wherein the real-time event notifications comprises breaches by a vehicle operator.

13. The method of claim 12, wherein the breaches by a vehicle operator include at least one of exceeding the speed set point and tampering by a vehicle operator.

14. The method of claim 1, wherein the step of auditing vehicle information or events is implemented through auditing means comprising a safe data store.

15. The method of claim 14, wherein the safe data store is located on board the vehicle.

16. The method of claim 14, wherein the safe data store is located in the Mobile Command and Control software or Acceleration Control Technology.

17. The method of claim 14, wherein the safe data store is located at a remote location with information from the vehicle's systems provided to the store over the air.

18. A method for the real-time management of the speed of a vehicle or fleet of vehicles comprising the steps of:
a. Remotely setting a variable maximum vehicle speed through software;
b. providing a vehicle on-board device operable for receiving over the air signals from the software;
c. controlling the vehicle or the fleet of vehicles from exceeding the set maximum vehicle speed by allowing operator control if the engine speed is less than the set maximum speed and interfering with operator control if the engine speed is greater than the set maximum vehicle speed;
d. adjusting the set maximum vehicle speed on the basis of vehicle information or external factors; and
e. providing event notifications by secure communication means, wherein the event notifications comprise at least one of vehicle speed, governor settings, operator speeding, tampering by a vehicle operator, interferences with Acceleration Control Technology, the vehicle location information and time.

19. The method of claim 18 wherein event notification are provided in real time.

20. An onboard controller system for a vehicle, comprising:
a. receiving means for receiving instructions for setting and adjusting a variable maximum vehicle speed;
b. TPS sensor means for receiving a genuine TPS signal from a throttle position sensor destined for an engine controller of the vehicle;
c. TPS spoof means for generating a spoofed TPS signal;
d. controller means for allowing operator control if the vehicle engine speed is less than the maximum vehicle speed setting and interfering with operator control if the vehicle engine speed is greater than the maximum vehicle speed setting, by selectively determining to send the genuine TPS signal to the engine controller if the vehicle engine speed is less than the maximum vehicle speed setting, or the spoofed TPS signal to the engine controller if the vehicle engine speed is greater than the maximum vehicle speed setting; and
e. auditing means for auditing vehicle information or events by providing event notifications by secure communication means.

21. The system of claim 20, wherein the setting of a maximum speed is implemented through software.

22. The system of claim 21, wherein the software comprises Mobile Command and Control software.

23. The system of claim 20, wherein the audit means further comprises a safe data store.

24. The system of claim 23, wherein the safe data store is located on board the vehicle.

25. The system of claim 24, wherein the safe data store is located in the Mobile Command and Control software.

26. The system of claim 23, wherein the safe data store is located at a remote location accessible over the air.

27. The system of claim 20, wherein the event notifications are in real time and comprise at least one of vehicle speed, governor settings, operator speeding, tampering by a vehicle operator, the vehicle location information and time.

28. The system of claim 20, wherein adjusting the selected maximum vehicle speed is done on the basis of vehicle information or external factors, and is done automatically by the system's components at the vehicle.
